(19) United States
(12) Patent Application Publication
(10) Pub. No.: US 2008/0178408 A1
(43) Pub. Date: Jul. 31, 2008

(54) WIPER BLADE ASSEMBLY

(76) Inventor: Ray King, Pickering (CA)

Correspondence Address: SCHMEISER, OLSEN & WATTS, 22 CENTURY HILL DRIVE, SUITE 302, LATHAM, NY, 12110, US

(21) Appl. No.: 11/669,288

(22) Filed: Jan. 31, 2007

(51) Int. Cl. B60S 1/38

(52) U.S. Cl. 15/250.06

(57) ABSTRACT

A windshield wiper assembly having a windshield wiper blade housing and a windshield wiper blade attached to the windshield wiper blade housing. A heating wire is affixed at one end to a rubber cover on the wiper blade and at another end to an electrical power source, wherein the electrical power source enables the heating wire to heat the wiper blade. A remote control device can be utilized for selectively activating and deactivating the heating wire in heating the wiper blade. Further, the heating wire is positioned externally to an interior or cab of the vehicle, whereby no wiring is required within the interior or cab of the vehicle.

This invention relates generally to vehicle windshield wiper assembly and, more particularly, to a windshield wiper assembly configured for use on vehicles in cold climates and temperatures below freezing.

### BACKGROUND OF THE INVENTION

A windshield wiper apparatus is a valuable safety apparatus for a vehicle such as a car or truck. Without effective performance of such a windshield wiper apparatus, visibility is generally dramatically impaired when driving a vehicle in inclement conditions. Examples of such inclement weather conditions include rain, snow, sleet, and fog.

Temperatures below freezing can present especially dangerous driving conditions for drivers. When accompanied by snow or rain, such below freezing temperatures can result in ice forming on the windshield of a car. Additionally, applying typical windshield washing solutions using a vehicle's windshield wash system can lead to an immediate icing of the windshield and wiper blades, particularly when the interior of the vehicle is near or below freezing temperatures. Regardless of the source, in any event, such formation of ice on a windshield impairs visibility and adversely impacts the performance of a conventional windshield wiper apparatus of a vehicle. The adverse impact on the performance of the vehicle's windshield wiper apparatus compounds the undesirable condition of ice forming on the vehicle's windshield and wiper blades. The end result is either an exceedingly dangerous driving situation or the inconvenience of having to manually remove the ice from the windshield and wiper blades.

Conventional windshield wiping apparatuses and assemblies that do not include a heating device are severely limited in that they do not include any means for counteracting below freezing temperatures and the formation of ice. Some conventional windshield wiping apparatuses do have heating devices that are intended to remedy the formation of ice on a windshield. However, conventional windshield wiping apparatuses that comprise a heating device either only heat the windshield wiper blade assembly itself (e.g., internal heating via resistive element within the windshield wiper blade) or, in other configurations, attempt to heat the windshield surface through radiant heating means. Internal heating of the windshield wiper blade assembly may provide limited ability to melt ice on the wider blade but such constructions can be limited in their ability to melt ice formed on the windshield. Radiant heating means are likewise limited in that their heating capacity is limited for this application and is adversely impacted by thermal cooling effect associated with movement of the windshield wiper blade assembly and/or vehicle.

Thus, there is a need for an improved windshield wiper assembly that can provide heating of the windshield wiper blade, whereby, through such heating, the formation of ice on the vehicle's windshields can be counteracted, and which can be heated by a wire connected to a car battery or other power source, the wire being affixed to the back of the wiper blade. Still farther, it would be advantageous if such a windshield wiper assembly can be operated by a remote control device, and which requires no wiring which is affixed to the wiper blade to enter into the interior of the vehicle.

### SUMMARY OF THE INVENTION

The object of the present invention is to provide an improved vehicle windshield wiper assembly able to provide heating of the windshield wiper blade assembly, whereby, through such heating, the formation of ice on the vehicle's windshields can be counteracted.

Another object of the present invention is to provide an improved vehicle windshield wiper assembly which is heated by a wire connected to a car battery or other power source, the wire being affixed to the back of the wiper blade.

A still further object of the present invention is to provide an improved vehicle windshield wiper assembly which can be operated by a remote control device, and which requires no wiring affixed to the wiper blade to enter into the interior of the vehicle.

According to one aspect of the present invention, there is provided a windshield wiper blade assembly, comprising a windshield wiper blade housing; a windshield wiper blade attached to the windshield wiper blade housing; and a heating wire affixed to each of the wiper blade and an electrical power source, the electrical power source enabling the heating wire to heat the wiper blade.

According to another aspect of the present invention, there is provided a windshield wiper blade assembly, comprising a windshield wiper blade housing; a windshield wiper blade attached to the windshield wiper blade housing; a heating wire affixed at one end to a rubber cover on the wiper blade and at another end to an electrical power source, wherein the electrical power source enables the heating wire to heat the wiper blade; and a remote control device for selectively activating and deactivating the heating wire in heating the wiper blade. a remote control device for selectively activating and deactivating the heating wire in heating the wiper blade.

According to still another aspect of the present invention, there is provided a windshield wiper blade housing, comprising a windshield wiper arm mounting member; a windshield wiper blade mounting structure configured for having a windshield wiper blade attached thereto, the windshield wiper blade mounting structure being mounted upon the windshield wiper arm mounting member; and a heating wire affixed to each of the wiper blade and an electrical power source within the vehicle, the electrical power source enabling the heating wire to heat the wiper blade.

As previously discussed, the advantage of the present invention is that it provides an improved vehicle windshield wiper assembly able to provide heating of the windshield wiper blade assembly, whereby, through such heating, the formation of ice on the vehicle's windshields can be counteracted.

A further advantage of the present invention is that it easily provides an improved vehicle windshield wiper assembly which is heated by a wire connected to a car battery or other power source, the wire being affixed to the back of the wiper blade.

A still further advantage of the present invention is that it provides an improved vehicle windshield wiper assembly which can be operated by a remote control device, and which requires no wiring affixed to the wiper blade to enter into the interior of the vehicle.

These and other objects and embodiments of the inventive disclosures made herein will become readily apparent upon further review of the following specification and associated drawings.

### BRIEF DESCRIPTION OF THE DRAWINGS

A preferred embodiment of the present invention is described below with reference to the accompanying drawings, in which:

FIG. 1 is a schematic diagram of one embodiment of the windshield wiper assembly of the present invention, for use in conjunction on a windshield of a vehicle and connected to a car battery;

FIG. 2 is a schematic diagram of an another embodiment of the windshield wiper assembly of the present invention, for use in conjunction on a windshield of a vehicle and connected to a car battery;

FIG. 3 is an illustration of three separate embodiments and variations of a windshield wiper blade for use in the windshield wiper assembly of the present invention;

FIG. 4 is a side view of one embodiment of the windshield wiper assembly of the present invention, for use in conjunction on a windshield of a vehicle and connected to a car battery; and

FIG. 5 is a side view of the heating wire connected to an inside of the rubber cover of the windshield wiper assembly.

### DESCRIPTION OF THE PREFERRED EMBODIMENT

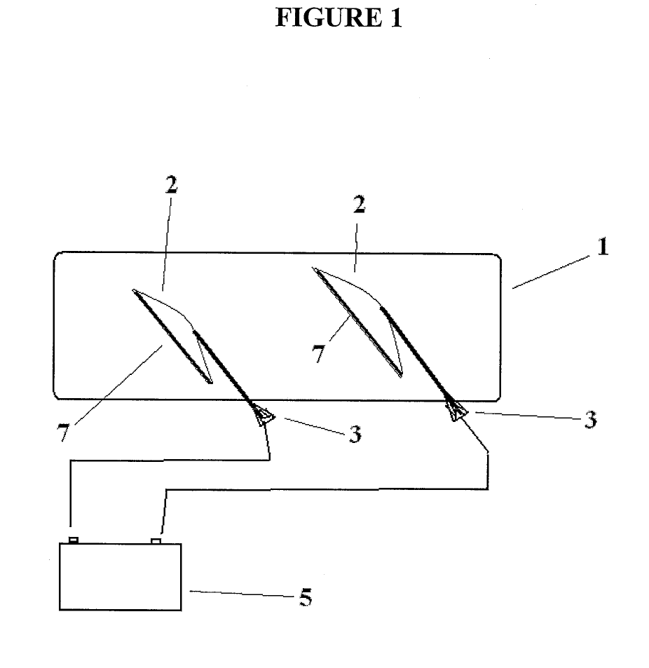

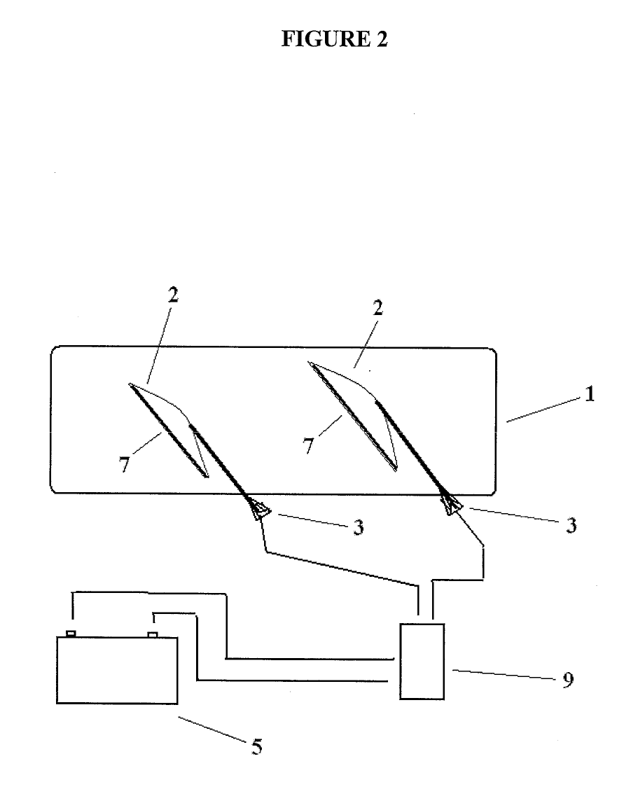

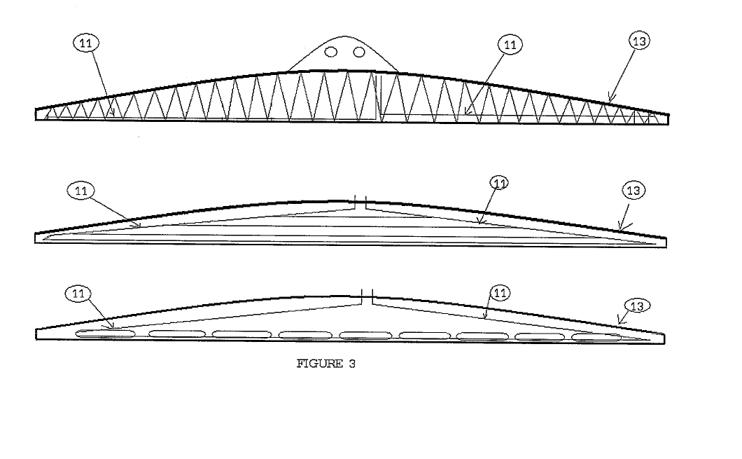

FIGS. 1 and 2 depict an embodiment of a windshield wiper assembly 2 in accordance with the inventive disclosures made herein. The windshield wiper assembly 2, which in FIGS. 1 and 2 illustrate a pair of windshield wiper assemblies working in conjunction, includes a windshield wiper blade assembly arm 3 and a windshield wiper blade assembly 7. The windshield wiper blade assembly arm 3 is attached at a first end to the windshield wiper blade assembly 7. A second end of the windshield wiper blade assembly arm 3 is configured for being attached to a windshield wiper motor assembly of a vehicle (not shown). Though the windshield wiper motor assembly of the vehicle and the windshield wiper blade assembly arm 3, the windshield wiper blade assembly 7 is movable across a surface of a windshield 1 of the vehicle. With reference to FIG. 3, there is also illustrated several variations of wiper blades 13, which illustrate the heating wire 11 being connected to the wiper blade 13, though it will be apparent to one skilled in the art that other variations are also possible.

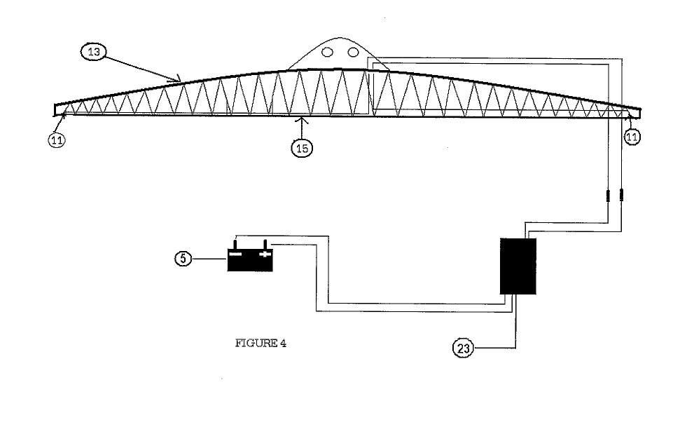

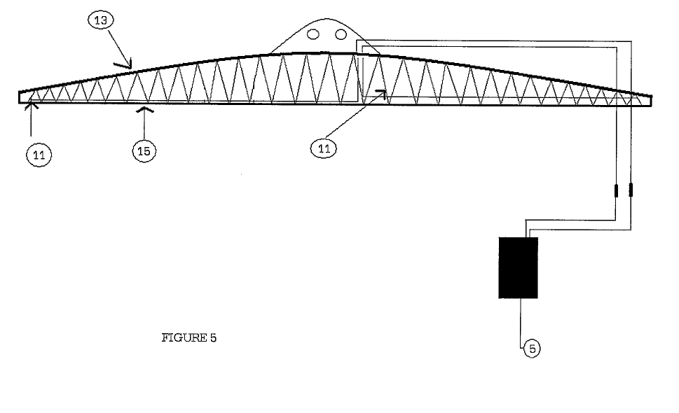

As can be seen in FIG. 1, a heating wire (not shown) is affixed to each of the wiper blade assemblies 7 and an electrical power source 5, the electrical power source enabling the heating wire to heat the wiper blade assemblies 7. Preferably, the heating wire is affixed to a rubber cover on the wiper blade, and the heating wire is an electrical heating wire, though it will be readily apparent to one skilled in the art that other configurations are possible. As an example, the heating wire can be laminated to the inside of the black rubber cover of the wiper blade. This can be seen with reference to FIGS. 4 and 5, which illustrate the heating wire 11 being laminated, in one embodiment of the present invention, to an inside of the rubber cover 15 of the wiper blade 13. Of course, the electrical power source 5 enables the heating wire 11 to heat the wiper blade 13. In a preferred embodiment, the wire draws current from the power source, when activated, at a steady rate so as to maintain the temperature being supplied to the rubber cover 15 of the wiper blade 13, and thus inhibit the formation of ice, snow or other visibility reducing impediments on the vehicle's windshield. In another embodiment of the present invention, the heating wire 11 is connected along an entire length of the wiper blade 13,can be connected to each end of the wiper blade, as can be seen in FIG. 5. Alternatively, the heating wire can, in another embodiment of the present invention, be connected at one end of the wiper blade, and extend a full length of the wiper blade.

Further, in the preferred embodiment, the electrical power source is an electrical car battery, though it is conceivable that other power sources, such as a solar cell, could also be utilized. In a still further embodiment, the heating wire is positioned externally to an interior of the vehicle, whereby no wiring with respect to the heating wire is required to enter within the interior or cab of the vehicle.

In a further embodiment of the present invention, and as can be seen in FIG. 2, a remote control device 9 can be used for selectively activating and deactivating the electrical power source to supply power to the heating wire and thus heating the wiper blade assemblies 7.

In a still further embodiment of the present invention, and as can be seen in FIG. 4, the heating wire 11 is laminated to an inside of the rubber cover 15 of the wiper blade 13. Of course, the electrical power source 5 enables the heating wire 11 to heat the wiper blade 13, by way of a receiver 23, which receives signals from a remote control device (not shown) which can be used for selectively activating and deactivating the electrical power source 5 to supply power to the heating wire and thus heating the wiper blade.

In another embodiment of the present invention (not shown) the windshield wiper assembly of the present invention could be a “clip on” attachment having a heating wire connected thereto which would draw current from a power source, when activated, at a steady rate so as to provide a temperature to the rubber cover of the wiper blade it is attached to, and thus inhibit the formation of ice, snow or other visibility reducing impediments on the vehicle's windshield. When desired to be removed, the embodiment could simply be detached from the wiper blade housing.

In an alternative embodiment, and as would be apparent to one skilled in the art, a windshield washing solution spray nozzle can also attached to the windshield wiper blade housing for use. Preferably, but not necessarily, the windshield washing solution spray nozzle is integrally formed with the windshield wiper blade housing, for enabling windshield wash solution to be sprayed on to the windshield of the vehicle through the windshield washing solution spray nozzle.

The present invention has been described herein with regard to preferred embodiments. However, it will be obvious to persons skilled in the art that a number of variations and modifications can be made without departing from the scope of the invention as described herein. There are numerous variations and modifications thereof that will also remain readily apparent to others skilled in the art, now that the general principles of the present invention have been disclosed.

The embodiments of the invention in which an exclusive property or privilege is claimed are defined as follows:

1. A windshield wiper blade assembly, comprising:
a windshield wiper blade housing;
a windshield wiper blade attached to the windshield wiper blade housing; and
a heating wire affixed to each of the wiper blade and an electrical power source, the electrical power source enabling the heating wire to heat the wiper blade.

2. The windshield wiper blade assembly of claim 1, wherein the heating wire is affixed to a rubber cover on the wiper blade.

3. The windshield wiper blade assembly of claim 1, wherein the electrical power source is an electrical car battery.

4. The windshield wiper blade assembly of claim 1, wherein the heating wire is an electrical heating wire.

5. The windshield wiper blade assembly of claim 1, wherein the heating wire is positioned externally to an interior of the vehicle.

6. A windshield wiper blade assembly for a vehicle, comprising:
a windshield wiper blade housing;
a windshield wiper blade attached to the windshield wiper blade housing;
a heating wire affixed at one end to a rubber cover on the wiper blade and at another end to an electrical power source, wherein the electrical power source enables the heating wire to heat the wiper blade; and
a remote control device for selectively activating and deactivating the heating wire in heating the wiper blade.

7. The windshield wiper blade assembly of claim 6, wherein the electrical power source is an electrical car battery.

8. The windshield wiper blade assembly of claim 7, wherein the heating wire is an electrical heating wire.

9. The windshield wiper blade assembly of claim 7, wherein the heating wire is positioned externally to an interior of the vehicle.

10. The windshield wiper blade assembly of claim 7, further comprising:
a windshield washing solution spray nozzle attached to the windshield wiper blade housing.

11. The windshield wiper blade assembly of claim 1, wherein the heating wire is affixed at one end to an inside potion of a rubber cover on the wiper blade, and at another end to the electrical power source.

12. The windshield wiper blade assembly of claim 1, wherein the heating wire extends along an entire length of the wiper blade.

13. The windshield wiper blade assembly of claim 11, wherein the heating wire extends along an entire length of the inside potion of the rubber cover on the wiper blade.

14. The windshield wiper blade assembly of claim 11, wherein the heating wire is laminated to the inside potion of the rubber cover on the wiper blade.

15. The windshield wiper blade assembly of claim 14, wherein the wiper blade assembly further comprises:
(a) the heating wire being affixed at one end to the wiper blade and at another end to a receiver, the receiver being connected to an electrical power source; and
(b) a remote control device for communicating with the receiver, the receiver permitting a user operating the remote control device to send a signal to the receiver to selectively activate the electrical power source to enable the heating wire to heat the wiper blade, and to, when desired, send a signal to the receiver to deactivate the electrical power source and cease the heating wire in heating the wiper blade.

16. A windshield wiper blade assembly for a vehicle, comprising:
a windshield wiper blade housing;
a windshield wiper blade attached to the windshield wiper blade housing;
a heating wire affixed at one end to a rubber cover on the wiper blade and at another end to
a receiver, the receiver being connected to an electrical power source; and
a remote control device for communicating with the receiver, the receiver permitting a user operating the remote control device to send a signal to the receiver to selectively activate the electrical power source to enable the heating wire to heat the wiper blade, and to, when desired, send a signal to the receiver to deactivate the electrical power source and cease the heating wire in heating the wiper blade.

17. The windshield wiper blade assembly of claim 1, wherein the windshield wiper blade is a clip on attachment removably securable to the wiper blade housing, the wiper blade having a heating wire connected thereto for drawing current from a power source, which, when activated, enables the heating wire to heat the wiper blade.
